(19) United States
(12) Patent Application Publication
(10) Pub. No.: US 2014/0325639 A1
(43) Pub. Date: Oct. 30, 2014

(54) ELECTRONIC DEVICE AND AUTHENTICATION METHOD

(71) Applicant: KABUSHIKI KAISHA TOSHIBA, Tokyo (JP)

(72) Inventor: Shuji HORI, Iruma-shi (JP)

(73) Assignee: KABUSHIKI KAISHA TOSHIBA, Tokyo (JP)

(21) Appl. No.: 14/251,977

(22) Filed: Apr. 14, 2014

(30) Foreign Application Priority Data
Apr. 26, 2013 (JP) 2013-093959

(51) Int. Cl. G06F 21/31

(52) U.S. Cl. CPC G06F 21/31
USPC 726/17

(57) ABSTRACT

According to one embodiment, a device gives a higher priority to a user when first authentication is successfully carried out than when second authentication is successfully carried out. The device includes a nonvolatile memory which stores a first password used for the first authentication, a position detector which detects a present position of the device, a first display processor which display a first input screen for accepting a third password input when the device is activated, and a second display processor which displays a second input screen for accepting the third password input, when the third password, which is input by using an input module when the first screen is displayed, is determined to be the first password and the present position is out of the permissible range.

### CROSS-REFERENCE TO RELATED APPLICATIONS

This application is based upon and claims the benefit of priority from Japanese Patent Application No. 2013-093959, filed Apr. 26, 2013, the entire contents of which are incorporated herein by reference.

### FIELD

Embodiments described herein relate generally to an electronic device and an authentication method.

### BACKGROUND

There is known a computer having a function of requesting an input of a so-called BIOS password, that is, an input of a password before booting an operating system. There are two kinds of BIOS passwords, by which different authorities are given to users.

When an input of a BIOS password has been requested, if a brutal-force attack is made, both of the two kinds of passwords would be cracked.

If a password, by which a high authority is given to the user, is hacked by a brutal-force attack at a time of a theft or loss, a user could use setup items or devices of a mobile terminal, which the supervisor does not wish a third person to use. In addition, when a password, which grants a high authority to the same user, is registered for all mobile terminals that are managed by the supervisor, such a dangerous situation may occur that the password, which grants the high authority to the same user and is registered for all mobile terminals managed by the supervisor, would be cracked.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view illustrating an example of the structure of a system according to an embodiment.

FIG. 2 is an exemplary view illustrating an example of the structure of a supervisor password authentication permission database file.

FIG. 3 is an exemplary view illustrating an example of the structure of a password avoidance permission database file.

FIG. 4 is an exemplary block diagram illustrating an example of the system configuration of an electronic device according to an embodiment.

FIG. 5 is an exemplary block diagram illustrating an example of the structure of a BIOS which executes a supervisor password authentication restriction process.

FIG. 6 is an exemplary view illustrating an example of a password input screen.

FIG. 7 is an exemplary view illustrating an example of the password input screen at a time when authentication failed.

FIG. 8 is an exemplary block diagram illustrating an example of the structure of a BIOS password input avoidance processor.

FIG. 9 is an exemplary view illustrating an example of a screen which is displayed in a password avoidance mode.

FIG. 10 is an exemplary flowchart illustrating a procedure of a supervisor password authentication restriction process.

FIG. 11 is an exemplary flowchart illustrating the procedure of the supervisor password authentication restriction process.

FIG. 12 is an exemplary flowchart illustrating the procedure of the supervisor password authentication restriction process.

FIG. 13 is an exemplary flowchart illustrating the procedure of the supervisor password authentication restriction process.

FIG. 14 is an exemplary flowchart illustrating the procedure of the supervisor password authentication restriction process.

FIG. 15 is an exemplary block diagram illustrating an example of the structure of the BIOS which executes the supervisor password authentication restriction process.

FIG. 16 is an exemplary flowchart illustrating an example of the procedure of an additional process in a second example.

FIG. 17 is an exemplary flowchart illustrating an example of process which is executed by the BIOS, when a password utility has requested a permission of a change of a user policy which requires supervisor password authentication.

FIG. 18 is an exemplary flowchart illustrating a procedure of a supervisor password authentication restriction process.

FIG. 19 is an exemplary flowchart illustrating the procedure of the supervisor password authentication restriction process.

FIG. 20 is an exemplary flowchart illustrating the procedure of the supervisor password authentication restriction process.

FIG. 21 is an exemplary flowchart illustrating the procedure of the supervisor password authentication restriction process.

### DETAILED DESCRIPTION

Various embodiments will be described hereinafter with reference to the accompanying drawings.

In general, according to one embodiment, an electronic device is configured to give a higher priority to a user when first authentication is successfully carried out than when second authentication is successfully carried out. The device includes a nonvolatile memory, a position detector, a first display processor, and a second display processor. The nonvolatile memory is configured to store a first password used for the first authentication. The second password is used for the second authentication. The range information is indicative of a permissible range. The position detector is configured to detect a present position of the electronic device. The first display processor is configured to display a first input screen for accepting a third password input when the device is activated. The second display processor is configured to display a second input screen for accepting the third password input, when the third password, which is input by using an input module when the first screen is displayed, is determined to be the first password and the present position is out of the permissible range.

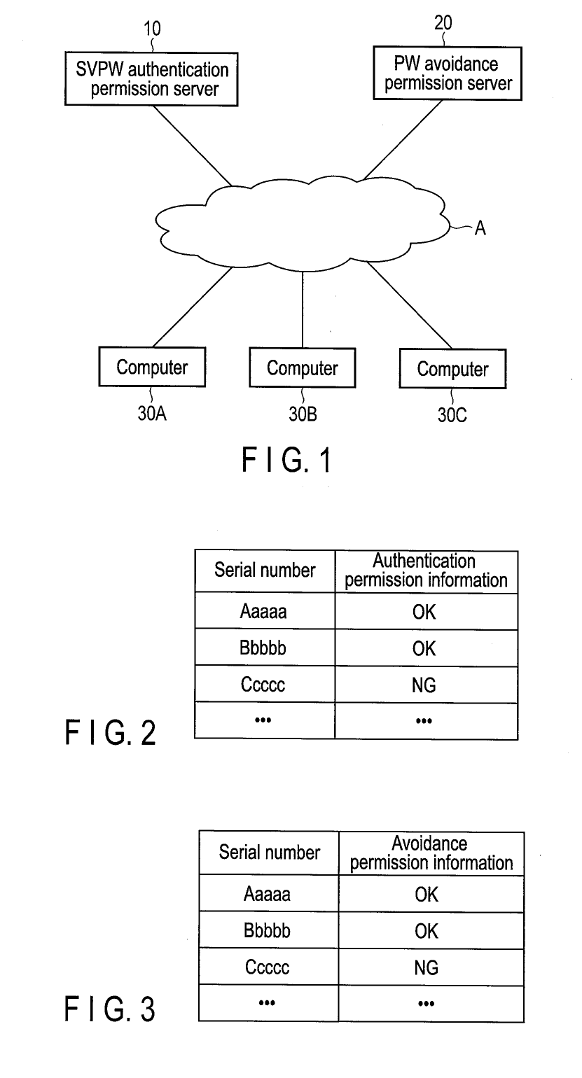

FIG. 1 illustrates the structure of a BIOS password management system.

The BIOS password management system includes an electronic device. The electronic device may be realized as an embedded system which is incorporated in various kinds of battery-powered portable electronic devices such as tablet computers, notebook-type personal computers, smartphones and PDAs. In the description below, the case is assumed that the electronic device is realized as a notebook-type personal computer 30.

As shown in FIG. 1, a supervisor password authentication permission server (SVPW authentication permission server) 10, a password avoidance permission server (PW avoidance permission server) 20, and computers 30A to 30C functioning as electronic devices are connected to a network A.

The SVPW authentication permission server 10 includes an authentication permission database file in which information (e.g. serial number) unique to each computer, 30A to 30C, and authentication permission information, which indicates whether or not to permit supervisor password authentication, are associated.

The computer 30 (30A to 30C) requests an input of a password at a time of power-on. If the input password agrees with a registered password and authentication is successfully carried out, the computer 30 boots the operating system. The password is a so-called BIOS password. There are two kinds of BIOS passwords which grant different authorities to users. One is a user password. The user password is a BIOS password which is used by a user who uses the computer. The other is a supervisor password (administrator password). The supervisor password is a BIOS password which is used by a supervisor. The user is not informed of the supervisor password.

When authentication with use of the supervisor password has successfully been carried out, all BIOS setups can be performed. In addition, the setup of the user password is performed when the authentication with use of the supervisor password has successfully been carried out. With the user password, some of the BIOS setups can be performed. In short, the authority, which is given to the user who successfully carried out authentication with use of the supervisor password, is higher than the authority, which is given to the user who successfully carried out authentication with use of the user password.

In addition, by performing a predetermined operation at a time of power-on, it is possible to boot the operating system by avoiding an input of the BIOS password.

FIG. 2 is a view illustrating an example of the structure of the supervisor password authentication permission database file. As illustrated in FIG. 2, serial numbers are associated with authentication permission information which indicates whether or not to permit supervisor password authentication for the serial numbers. Normally, serial numbers are associated with “OK” indicating permission of supervisor password authentication. In the case of a computer which was stolen or a computer which was lost, the serial number is associated with “NG” indicating non-permission of supervisor password authentication.

The PW avoidance permission server 20 includes an avoidance permission database file in which information (e.g. serial number) unique to each computer, 30A to 30C, and avoidance permission information, which indicates whether or not to permit BIOS password authentication, are associated.

FIG. 3 is a view illustrating an example of the structure of the password avoidance permission database file. As illustrated in FIG. 3, serial numbers are associated with avoidance permission information which indicates whether or not to permit avoidance of BIOS password authentication for the serial numbers. Normally, serial numbers are associated with “OK” indicating permission of avoidance of BIOS authentication (authentication with use of the user password, and authentication with use of the supervisor password). In the case of a computer which was stolen or a computer which was lost, the serial number is associated with “NG” indicating non-permission of avoidance of BIOS password authentication.

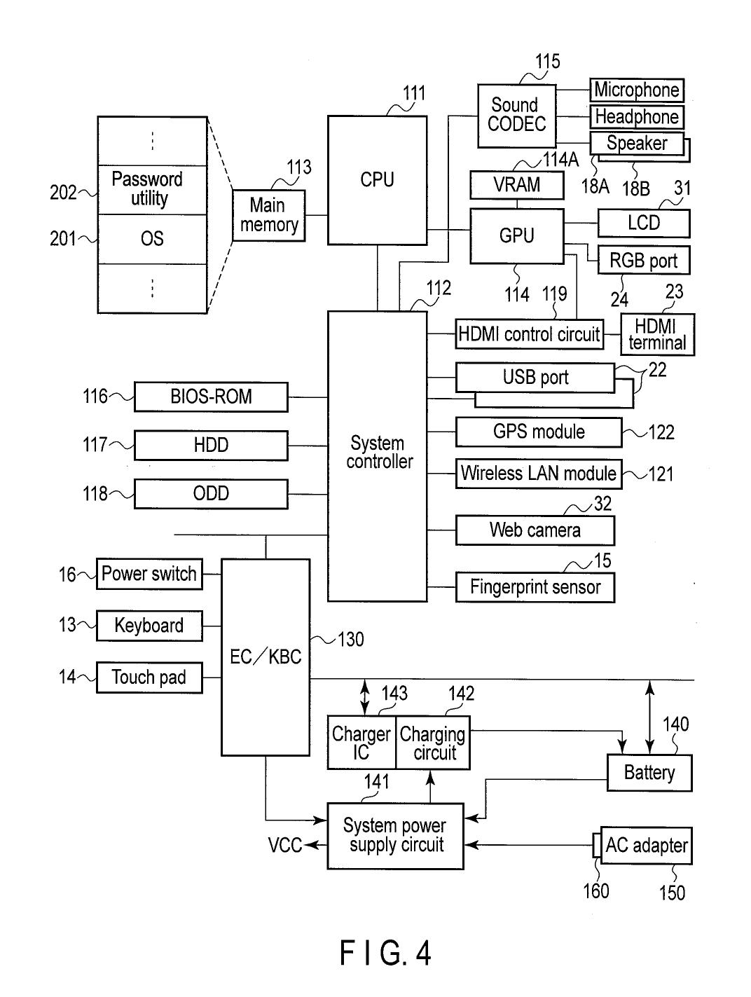

FIG. 4 is a block diagram illustrating the system configuration of each computer.

FIG. 4 shows the system configuration of the personal computer 30 in the embodiment. The personal computer 30 includes a CPU 111, a system controller 112, a main memory 113, a graphics processing unit (GPU) 114, a sound CODEC 115, a BIOS-ROM 116, a hard disk drive (HDD) 117, an optical disc drive (ODD) 118, a wireless LAN module 121, a GPS module 122, an embedded controller/keyboard controller IC (EC/KBC) 130, a system power supply circuit 141, a charging circuit 142, and a charger IC 143.

The CPU 111 is a processor which controls operations of the respective components of the personal computer 30. The CPU 111 executes various programs which are loaded from the HDD 117 into the main memory 113. The programs include an operating system (OS) 201 and various application programs. The various applications include a password utility 202. The password utility 202 is an application program for setting up a user policy. The user policy is a function of restricting operations of general users, when the computer 30 is used by a plurality of users. By setting up the user policy, it becomes possible to restrict operations of setups of the user password, BIOS password, and HDD password. When the password utility 202 is started, an input of the supervisor password is requested. When the input password agrees with the registered supervisor password, the user policy can be set up.

In addition, the CPU 111 executes a basic input/output system (BIOS) which is stored in the BIOS-ROM 116 that is a nonvolatile memory. The BIOS is a system program for hardware control.

The GPU 114 is a display controller which controls an LCD 31 that is used as a display monitor of the personal computer 30. The GPU 114 generates a display signal (LVDS signal) which is to be supplied to the LCD 31, from display data stored in a video memory (VRAM) 114A. Further, the GPU 114 can generate an analog RGB signal and an HDMI video signal from display data. The analog RGB signal is supplied to an external display via an RGB port 24. An HDMI output terminal 23 can send out an HDMI video signal (non-compressed digital video signal) and a digital audio signal to the external display over a single cable. An HDMI control circuit 119 is an interface for sending out the HDMI video signal and digital audio signal to the external display via the HDMI output terminal 23.

The system controller 112 is a bridge device which connects the CPU 111 and the respective components. The system controller 112 includes a serial ATA controller for controlling the hard disk drive (HDD) 117 and optical disc drive (ODD) 118.

In addition, devices, such as USB ports 22, wireless LAN module 121, GPS module 122, a Web camera 32 and a fingerprint sensor 15, are connected to the system controller 112.

Furthermore, the system controller 112 communicates with each device which is connected via a bus.

The EC/KBC 130 is connected to the system controller 112 via a bus. In addition, the EC/KBC 130 is interconnected to the charger IC 143 and a battery 140 via a serial bus.

The EC/KBC 130 is a power management controller for power management of the personal computer 30, and is realized as a one-chip microcomputer including a keyboard controller which controls, for example, a keyboard (KB) 13 and a touch pad 14. The EC/KBC 130 includes a function of powering on and powering off the personal computer 30 in accordance with an operation of a power switch 16 by the user. The power-on/power-off control of the personal computer 30 is executed on the system power supply circuit 141 by the EC/KBC 130.

The charger IC 143 is an IC for controlling the charging circuit 142 under the control of the EC/KBC 130. Even while the personal computer 30 is powered off, the EC/KBC 130, charger IC 143 and system power supply circuit 141 are operated by power from the battery 140 or an AC adapter 150.

The system power supply circuit 141 generates power (operation power) which is to be supplied to each component, by using power from the battery 140, or power from the AC adapter 150 which is connected to the computer 30 as an external power supply. In addition, the system power supply circuit 141 supplies power for charging the battery 140 by the charging circuit 142.

Under the control of the charger IC 143, the charging circuit 142 charges the batter 140 with power supplied via the system power supply circuit 141.

The AC adapter 150 can be attached to the computer 30. When the AC adapter 150 is attached to the computer 30, the AC adapter 150 is connected to a built-in connector 160.

When the power switch 16 of the computer 30 is pressed by the user, the BIOS starts a POST (Power On Self Test) process. After the POST process, the BIOS boots the operating system.

During the POST process, a supervisor password authentication restriction process is executed. The supervisor password authentication restriction process is a process which does not execute supervisor password authentication when the computer 30 was stolen or lost.

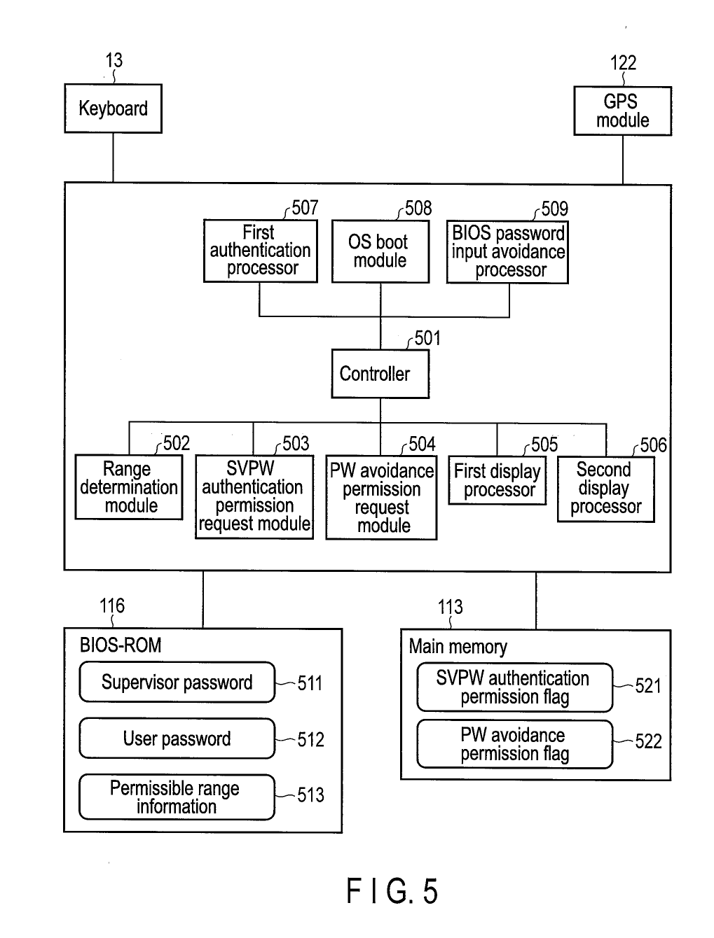

FIG. 5 is a block diagram illustrating the structure of a BIOS which executes the supervisor password authentication restriction process.

A BIOS 500 includes a controller 501, a range determination module 502, an SVPW authentication permission request module 503, a password avoidance permission request module 504, a first display processor 505, a second display processor 506, a first authentication processor 507, an OS boot module 508, and a BIOS password input avoidance processor 509.

The BIOS 500 refers to a supervisor password 511, a user password 512 and permissible range information 513 in the BIOS-ROM 116. In addition, the BIOS 500 refers to an SVPW authentication permission flag 521 and a PW avoidance permission flag 522 in the main memory 113.

When “1” is set as the value of the SVPW authentication permission flag 521 and as the value of the PW avoidance permission flag 522, this means “permission”. When “0” is set as the value of the SVPW authentication permission flag 521 and as the value of the PW avoidance permission flag 522, this means “non-permission”.

The supervisor password 511 and user password 512 are used at a time of BIOS authentication. The permissible range information 513 includes reference position information indicative of the latitude/longitude of a reference position, and distance information indicative of a set distance.

The SVPW authentication permission flag 521 indicates whether or not to permit authentication with use of a supervisor password (hereinafter referred to as “SVPW authentication”). The PW avoidance permission flag 522 indicates whether or not to avoid an input of a BIOS password. When the distance between a measured position by the GPS module 122 and a reference position is greater than a set distance, the SVPW authentication permission flag 521 and the PW avoidance permission flag 522 are referred to by the BIOS. That the distance between the measured position and the reference position is greater than the set distance means that the distance between the measured position and the reference position is not within a permissible range. In addition, when position measurement by the GPS module 122 has failed, the SVPW authentication permission flag 521 and the PW avoidance permission flag 522 are referred to by the BIOS.

The controller 501 controls the respective modules relating to the supervisor password authentication restriction process. The range determination module 502 determines whether the present position is within the permissible range, based on the position measured by the GPS module 122 and the permissible range information 513. The range determination module 502 notifies the controller 501 of the determination result.

[Within the Permissible Range]

When it has been notified that the present position is within the permissible range, the controller 501 sets “1” for the value of the SVPW authentication permission flag 521 and sets “1” for the value of the PW avoidance permission flag 522.

[Out of the Permissible Range]

When it has been notified by the range determination module 502 that the present position is out of the permissible range, the controller 501 determines whether the computer 30 is connected to the network A or not.

When it has been determined that the computer 30 is not connected to the network A, the controller 501 determines whether the SVPW authentication server 10 exists on the network.

When it has been determined that the SVPW authentication server 10 does not exist on the network, the controller 501 sets “0” for the value of the SVPW authentication permission flag. When it has been determined that the SVPW authentication server 10 exists on the network, the controller 501 requests the SVPW authentication permission request module 503 to request permission of SVPW authentication from the SVPW authentication server 10. Responding to the request, the SVPW authentication permission request module 503 requests permission of SVPW authentication from the SVPW authentication server 10. The SVPW authentication permission request module 503 receives a notification indicative of a result corresponding to the request from the SVPW authentication server 10. The SVPW authentication permission request module 503 delivers the notification from the SVPW authentication server 10 to the controller 501. When the notification from the SVPW authentication server 10 is indicative of permission, the controller 501 sets “1” for the value of the SVPW authentication permission flag. When the notification from the SVPW authentication server 10 is not indicative of permission, the controller 501 sets “0” for the value of the SVPW authentication permission flag.

In addition, when it has been determined that the computer 30 is connected to the network A, the controller 501 determines whether the PW avoidance permission server 20 exists on the network. When it has been determined that the PW avoidance permission server 20 does not exist on the network, the controller 501 sets “0” for the value of the PW avoidance permission flag. When it has been determined that the PW avoidance permission server 20 exists on the network, the controller 501 requests the PW avoidance permission request module 504 to request permission of avoidance of a BIOS password input from the PW avoidance permission server 20. Responding to the request, the PW avoidance permission request module 504 requests permission of avoidance of a BIOS password input from the PW avoidance permission server 20. The PW avoidance permission request module 504 receives a notification indicative of a result corresponding to the request from the PW avoidance permission server 20. The PW avoidance permission request module 504 delivers the notification from the PW avoidance permission server 20 to the controller 501. When the notification from the PW avoidance permission server 20 is indicative of permission, the controller 501 sets “1” for the value of the PW avoidance permission flag. When the notification from the PW avoidance permission server 20 is not indicative of permission, the controller 501 sets “0” for the value of the PW avoidance permission flag.

[Password Input]

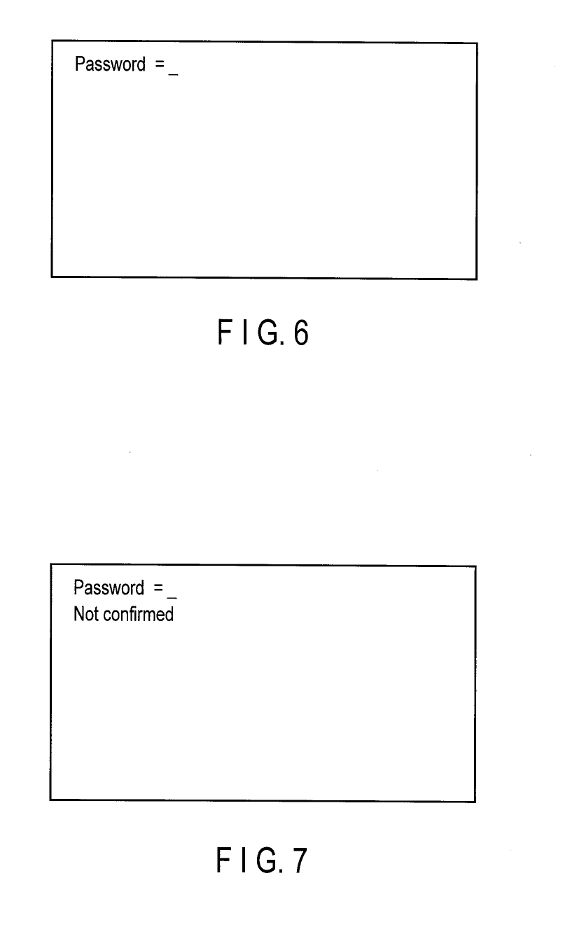

The controller 501 requests the first display processor 505 to display a first input screen for the user to input a password. Responding to the request, the first display processor 505 executes a process for displaying the first input screen on the LCD 31. FIG. 6 is a view illustrating an example of the first input screen. As shown in FIG. 6, “Password=_” is displayed on the display screen of the LCD 31.

When the first input screen is displayed, the controller 501 determines which of the supervisor password 511 and user password 512 the password, which has been input by using the keyboard 13, agrees with. When it has been determined that the input password agrees with the user password 512, the controller 501 notifies the password, which has been input by using the keyboard 13, to the first authentication processor 507. The first authentication processor 507 determines which of the supervisor password 511 and user password 512 the password, which has been input when the first input screen is displayed, agrees with. The first authentication processor 507 notifies the controller 501 that the input password agrees with the user password 512. The controller 501 requests the OS boot module 508 to boot the operating system 201. Responding to the request, the OS boot module 508 executes a process for booting the operating system 201.

When it has been determined that the input password agrees with neither the supervisor password 511 nor the user password 512, the controller 501 determines whether an input operation for avoiding an input of the BIOS password has been executed on the keyboard 13. When the input operation has not been executed, the controller 501 requests the second display processor 506 to display a second input screen for the user to re-input the password. Responding to the request, the second display processor 506 executes a process for causing the LCD 31 to display the second input screen. FIG. 7 is a view illustrating an example of the second input screen. As shown in FIG. 7, “Password=_” and “Not confirmed” are displayed on the display screen of the LCD 31. With the “Not confirmed” being displayed on the second input screen, the user is notified that the input password agrees with neither the supervisor password 511 nor the user password 512. Incidentally, the second display processor 506 may display the first input screen shown in FIG. 6, instead of the second input screen.

The first authentication processor 507 determines which of the supervisor password 511 and user password 512 the password, which has been input when the second input screen is displayed, agrees with. The first authentication processor 507 notifies the determination result to the controller 501. When the notification indicates that the input password agrees with either the supervisor password 511 or user password 512, the controller 501 requests the OS boot module 508 to boot the operating system 201. Responding to the request, the OS boot module 508 executes a process for booting the operating system 201. When the notification from the first authentication processor 507 indicates that the input password agrees with neither the supervisor password 511 nor the user password 512, the controller 501 requests the second display processor 506 to display the second input screen for the user to re-input the password.

When the sum of the number of times of input of the password at a time when the first input screen is displayed and the number of times of input of the password at a time when the second input screen is displayed has exceeded a preset number, the controller 501 executes a process for turning off the power to the computer 30.

When it has been determined that the input password agrees with the supervisor password 511, the controller 501 determines whether the value of the SVPW authentication permission flag 521 is “1” or not. When it has been determined that the value of the SVPW authentication permission flag 521 is “1”, the controller 501 notifies the first authentication processor 507 of the password which has been input by using the keyboard 13. The first authentication processor 507 determines which of the supervisor password 511 and user password 512 the password, which has been input when the first input screen is displayed, agrees with. The first authentication processor 507 notifies the controller 501 that the input password agrees with the supervisor password 511. The controller 501 requests the OS boot module 508 to boot the operating system 201. Responding to the request, the OS boot module 508 executes a process for booting the operating system 201.

When it has been determined that the value of the SVPW authentication permission flag 521 is not “1”, the controller 501 requests the second display processor 506 to display the second input screen for the user to re-input the password.

When it has been determined that the input operation for avoiding the input of the BIOS password has been executed, the controller 501 determines whether the value of the PW avoidance permission flag 522 is “1” or not. When it has been determined that the value of the PW avoidance permission flag 522 is not “1”, the controller 501 requests the second display processor 506 to display the second input screen for the user to re-input the password.

When it has been determined that the value of the PW avoidance permission flag 522 is “1”, the controller 501 requests the BIOS password input avoidance processor 509 to transit to a password avoidance mode and to execute a BIOS password input avoidance process.

[Password Avoidance Mode]

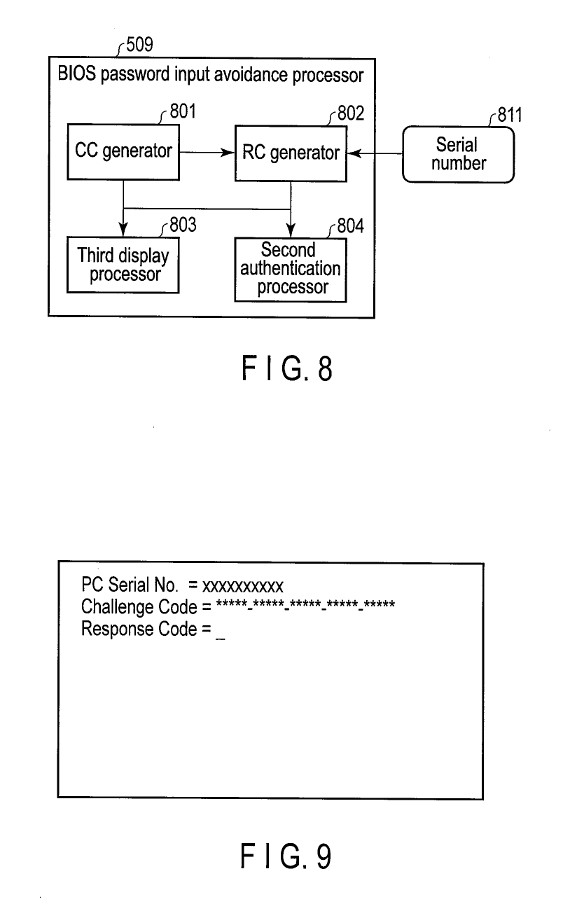

FIG. 8 is a block diagram illustrating the structure of the BIOS password input avoidance processor 509. As shown in FIG. 8, the BIOS password input avoidance processor 509 includes a challenge code generator (CC generator) 801, a response code generator (RC generator) 802, a third display processor 803 and a second authentication processor 804.

The challenge code generator 801 generates a challenge code. The challenge code generator 801 may be a module which generates a random number.

The response code generator 802 generates a response code, based on a mathematical algorithm using a challenge code and a serial number.

The third display processor 803 causes the LCD 31 to display a code input screen for the user to input a response code. A serial number 811 and a challenge code are displayed on the code input screen. FIG. 9 is a view illustrating an example of the code input screen. As shown in FIG. 9, the serial number 811 and a challenge code are displayed on the code input screen.

The user reports the serial number 811 and the challenge code to the support of the maker. The support generates a response code, based on a mathematical algorithm using the reported serial number 811 and challenge code. The support notifies the generated response code to the user. The user inputs the notified response code by using the keyboard 13.

The second authentication processor 804 executes an authentication process of determining whether the response code generated by the response code generator 802 agrees with the input response code. The second authentication processor 804 notifies the determination result to the controller 501.

When the notification indicates the success of authentication, the controller 501 requests the OS boot module 508 to boot the operating system 201. Responding to the request, the OS boot module 508 executes the process for booting the operating system 201.

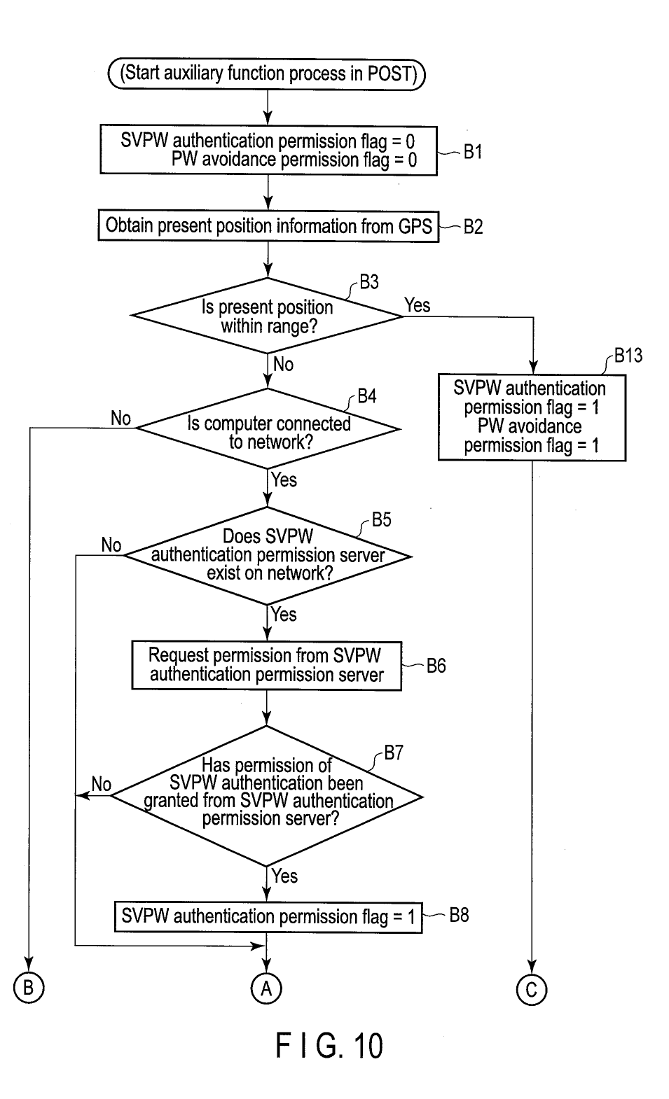

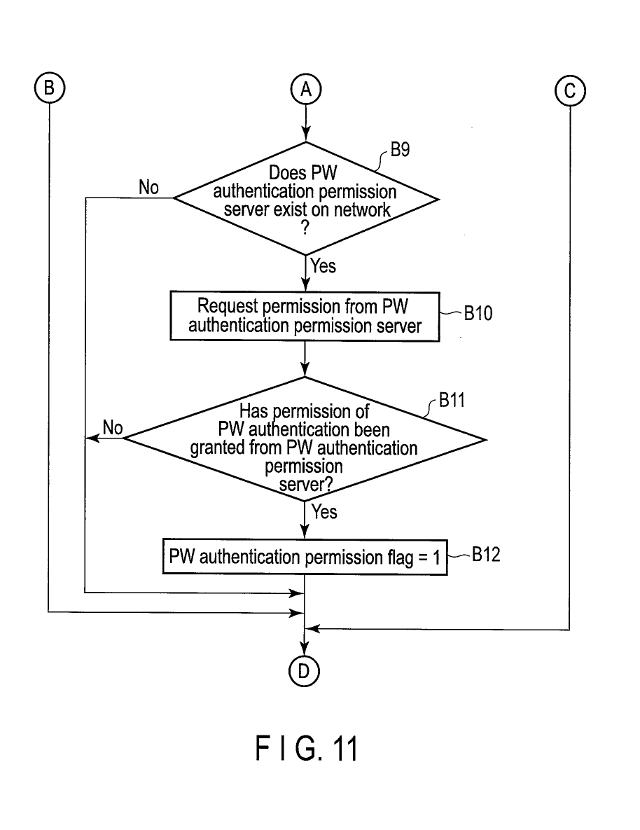

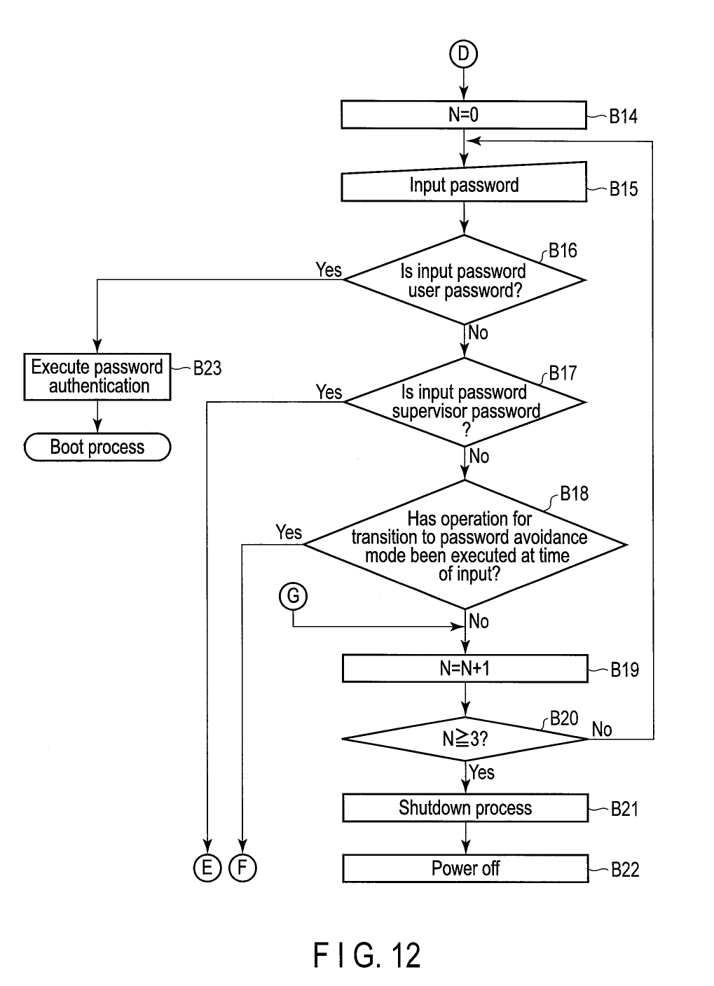

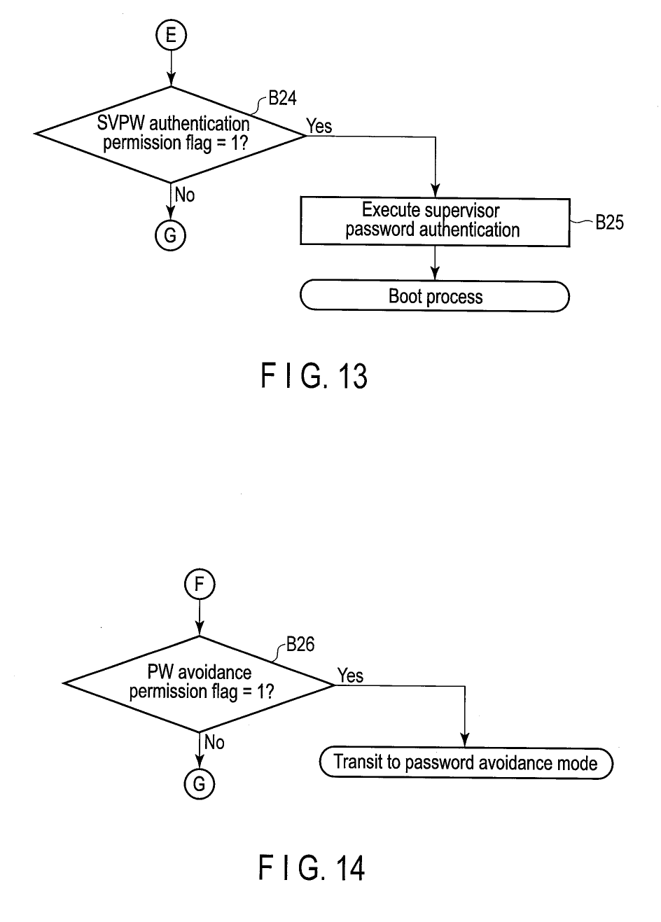

FIG. 10 to FIG. 14 are flowcharts illustrating the procedure of a supervisor password authentication restriction process.

The controller 501 sets “0” for the value of the SVPW authentication permission flag 521 and sets “0” the value of the PW avoidance permission flag 522, which are variables in the memory 113 (block B1).

The range determination module 502 obtains position information indicative of the present position from the GPS module 122 (block B2). The range determination module 502 calculates a distance between the present position indicated by the position information, which has been acquired from the GPS module 122, and the reference position in the permissible range information 513. The range determination module 502 determines whether the present position is within the permissible range, by comparing the calculated distance and the permissible distance in the permissible range information 513 (block B3).

When it has been determined that the present position is within the permissible range (Yes in block B3), the controller 501 sets “1” for the value of the SVPW authentication permission flag 521 and sets “1” for the value of the PW avoidance permission flag 522 in the memory 113 (block B13).

When it has been determined that the present position is not within the permissible range (No in block B3), the controller 501 determines whether the computer 30 is connected to the network (block B4).

When it has been determined that the computer 30 is connected to the network (Yes in block B4), the controller 501 determines whether the SVPW authentication server 10 exists on the network (block B5). When it has been determined that the SVPW authentication server 10 exists on the network (Yes in block B5), the SVPW authentication permission request module 503 issues a request for permission of SVPW authentication, together with the unique information and serial number of the computer 30, to the SVPW authentication server 10 (block B6).

Based on the unique information, the SVPW authentication server 10 refers to the authentication permission database file, determines whether or not to permit SVPW authentication to the computer 30 which issued the request, and notifies the determination result to the computer 30.

When the notification has been received from the SVPW authentication permission server 10, the controller 501 determines whether the SVPW authentication has been permitted or not, based on the notification (block B7). When the SVPW authentication has been permitted (Yes in block B7), the controller 501 sets “1” for the value of the SVPW authentication permission flag 521 (block B8).

When it has been determined in block B5 that the SVPW authentication server 10 does not exist on the network (No in block B5) or when the SVPW authentication has not been permitted in block B7 (No in block B7), the controller 501 determines whether the PW avoidance permission server 20 exists on the network (block B9). When it has been determined that the PW avoidance permission server 20 exists (Yes in block B9), the password (PW) avoidance permission request module 504 issues a request for permission of avoidance of a BIOS password input, together with the unique information of the computer 30, to the PW avoidance permission server 20 (block B10).

Based on the unique information, the PW avoidance permission server 20 refers to the avoidance permission database file, determines whether or not to permit the avoidance of the BIOS password input to the computer 30 which issued the request, and notifies the determination result to the computer 30.

When the notification has been received from the PW avoidance permission server 20, the controller 501 determines whether the avoidance of the BIOS password input has been permitted or not, based on the notification (block B11). When the avoidance of the BIOS password input has been permitted (Yes in block B7), the controller 501 sets “1” for the value of the PW avoidance permission flag 522 (block B12).

When it has been determined in block B4 that the computer 30 is not connected to the network (No in block B4), or after the process of block B13, or when it has been determined in block B9 that the PW avoidance permission server 20 does not exist on the network (No in block B9), or after the process of block B12, the controller 501 sets “0” for the value of N indicative of the number of times of input of the password (block B14).

The first display processor 505 executes a process for causing the LCD 31 to display the first input screen shown in FIG. 6. The user performs a password input from the keyboard or an operation for a transition to the PW avoidance mode (block B15).

The controller 501 determines whether the input password agrees with the user password 512 which is registered in the BIOS-ROM 109 (block B16). When it has been determined that the input password agrees with the user password 512 (Yes in block B16), the first authentication processor 507 executes user password authentication (block B23), and then the OS boot module 508 boots the operating system 201.

When it has been determined that the input password does not agree with the user password 512 (No in block B16), the controller 501 determines whether the input password agrees with the supervisor password 511 which is registered in the BIOS-ROM 109 (block B17).

When it has been determined that the input password does not agree with the supervisor password 511, the controller 501 determines whether the operation for the transition to the password avoidance mode was executed when the password was input (block B18). When it has been determined that this operation was not executed (No in block B18), the controller 501 increments the value of N by 1 (block B19). The controller 501 determines whether the value of N is 3 or more (block B20). If it is determined that the value of N is not 3 or more (No in block B20), the BIOS 500 successively executes the process from block B15. If it is determined that the value of N is 3 or more (Yes in block B20), the controller 501 executes a shutdown process (block B21), and powers off the computer 30 (block B22).

When it has been determined in block B17 that the input password agrees with the supervisor password 511 (Yes in block B17), the controller 501 determines whether the value of the SVPW authentication permission flag 521 is “1” or not (block B24). When it has been determined that the value of the SVPW authentication permission flag 521 is not “1” (No in block B24), the BIOS 500 successively executes the process from block B19. When the value of the SVPW authentication permission flag 521 is “0”, SVPW authentication is not executed. It is thus possible to prevent hacking of the supervisor password by a brutal-force attack.

When it has been determined that the value of the SVPW authentication permission flag 521 is “1” (Yes in block B24), the first authentication processor 507 executes supervisor password authentication (block B25), and then the OS boot module 508 boots the operating system 201.

When it has been determined in block B18 that the operation for the transition to the password avoidance mode was executed (Yes in block B18), the controller 501 determines whether the value of the PW avoidance permission flag 522 is “1” or not (block B26). When it has been determined that the value of the PW avoidance permission flag 522 is not “1” (No in block B26), the controller 501 successively executes the process from block B19. When it has been determined that the value of the PW avoidance permission flag 522 is “1”, the BIOS password input avoidance processor 509 executes a transition to the password avoidance mode.

[First Modification]

Prior to executing an authentication restriction function support process, a process described below may be executed.

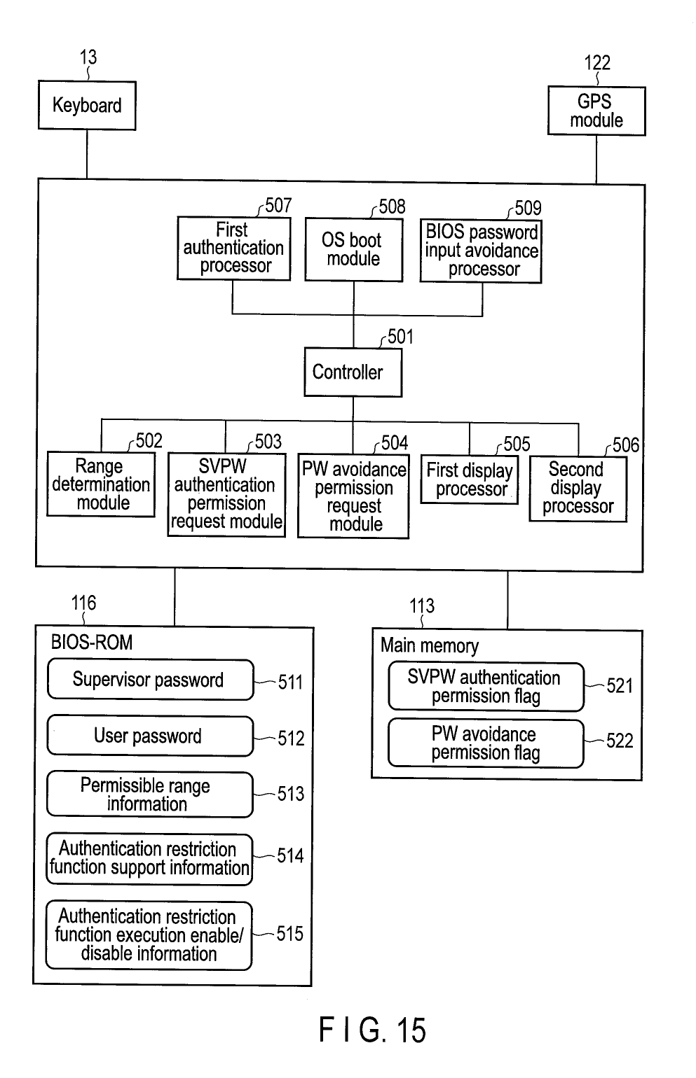

FIG. 15 is a block diagram illustrating an example of the structure of the BIOS which executes the supervisor password authentication restriction process.

The BIOS 500 refers to authentication restriction function support information 514 and authentication restriction function execution enable/disable information 515, in addition to the data which is referred to in the first embodiment.

The authentication restriction function support information 514 indicates whether the supervisor password authentication restriction function is supported or not. The authentication restriction function execution enable/disable information 515 indicates whether the supervisor password authentication restriction function is executed or not. The authentication restriction function execution enable/disable information 515 is effective only when the authentication restriction function support information 514 indicates that the supervisor password authentication restriction function is supported.

In the meantime, only the manufacturer of the computer can set up the authentication restriction function support information 514. The user cannot set up the authentication restriction function support information 514. The setup means of the authentication restriction function execution enable/disable information 515 is provided to only the supervisor (administrator).

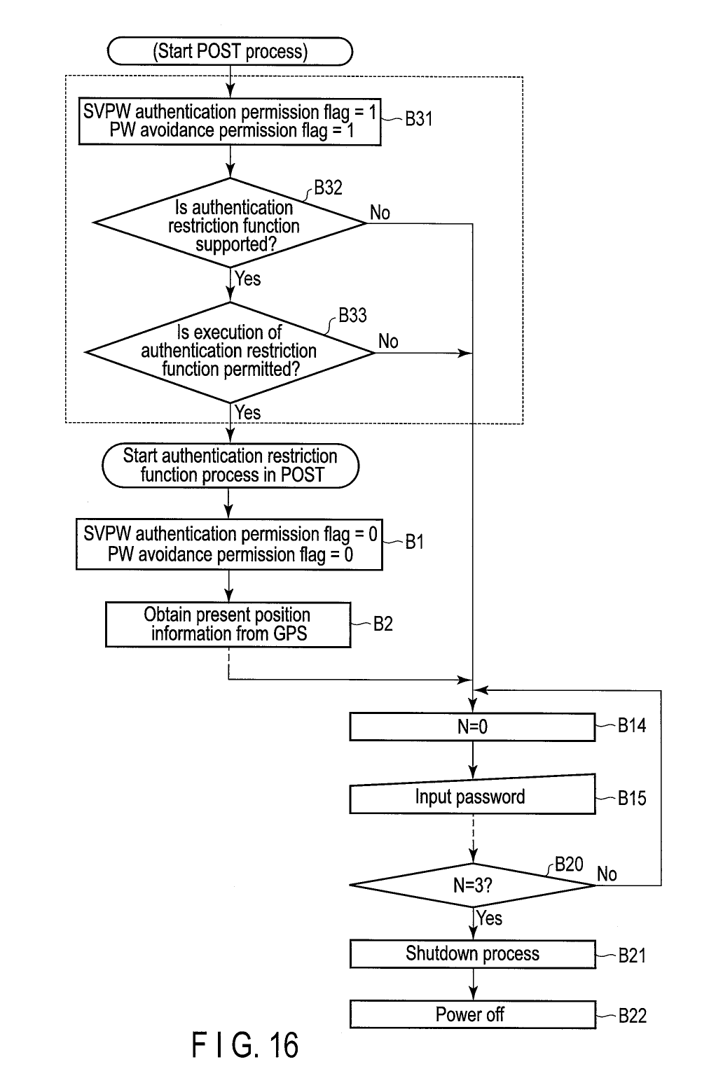

FIG. 16 is a flowchart illustrating the procedure of an additional process. A range indicated by a broken line is the range of the added process.

If the power switch is pressed by the user, the BIOS 500 starts a POST process. The controller 501 sets “0” for the value of the SVPW authentication permission flag 521 and sets “0” for the value of the PW avoidance permission flag 522, which are variables in the memory 113 (block B31).

The controller 501 refers to the authentication restriction function support information 514 in the BIOS-ROM 109, thereby determining whether the authentication restriction function is supported or not (block B32). When it has been determined that the authentication restriction function is supported (Yes in block B32), the controller 501 refers to the authentication restriction function execution enable/disable information 515 in the BIOS-ROM 109, thereby determining whether the execution of the authentication restriction function is permitted or not (block B33). When it has been determined that the execution of the authentication restriction function is permitted (Yes in block B33), the BIOS 500 starts the authentication restriction function process, and successively executes the process from block B1.

When it has been determined in block B32 that the authentication restriction function is not supported, or when it has been determined in block B33 that the execution of the authentication restriction function is not permitted (No in block B33), the BIOS 500 successively executes the process from block B14.

[Second Modification]

In a third example, a description is given of a process after the operating system 201 is booted.

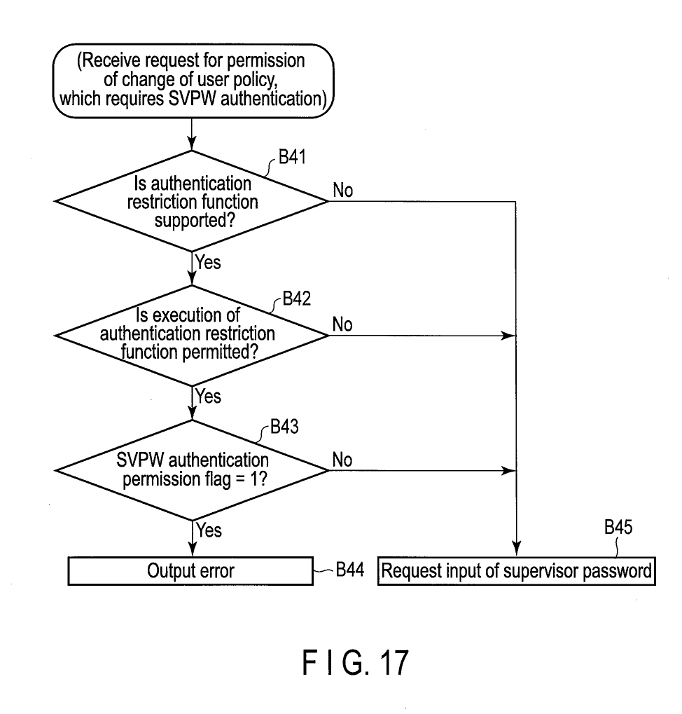

FIG. 17 is a flowchart illustrating an example of a process which is executed by the BIOS, when the password utility has requested permission of a change of a user policy, which requires supervisor password authentication.

The BIOS 500 receives a request for permission of a change of a user policy, which requires supervisor password authentication, from the password utility 202.

The controller 501 refers to the authentication restriction function support information 514 in the BIOS-ROM 109, thereby determining whether the authentication restriction function is supported or not (block B41). When it has been determined that the authentication restriction function is supported (Yes in block B41), the controller 501 refers to the authentication restriction function execution enable/disable information 515 in the BIOS-ROM 109, thereby determining whether the execution of the authentication restriction function is permitted or not (block B42). When it has been determined that the execution of the authentication restriction function is permitted (Yes in block B42), the controller 501 determines whether the value of the SVPW authentication permission flag is “1” or not, by referring to the SVPW authentication permission flag in the memory 113 (block B43). When it has been determined that the value of the SVPW authentication permission flag is “1” (Yes in block B43), the controller 501 outputs to the password utility 202 an error indicative of refusal of the request from the password utility 202 (block B44).

When it has been determined in block B41 that the authentication restriction function is not supported, or when it has been determined that the execution of the authentication restriction function is not permitted (No in block B42), or when it has been determined that the value of the SVPW authentication permission flag is not “1” (No in block B43), the controller 501 requests the password utility 202 to input the supervisor password, this indicating the permission of the request from the password utility 202.

[Third Modification]

In the above-described embodiment, when the present position is not within the permissible range, a permission of authentication using the supervisor password is requested from the SVPW authentication permission server 10. However, in the above-described embodiment, when the present position is not within the permissible range, it is possible to disable the authentication using the supervisor password, without requesting the permission. In addition, when the present position is not within the permissible range, a permission of avoidance of the BIOS password input is requested from the PW avoidance permission server 20. However, in the above-described embodiment, when the present position is not within the permissible range, it is possible to disable the avoidance of the BIOS password input.

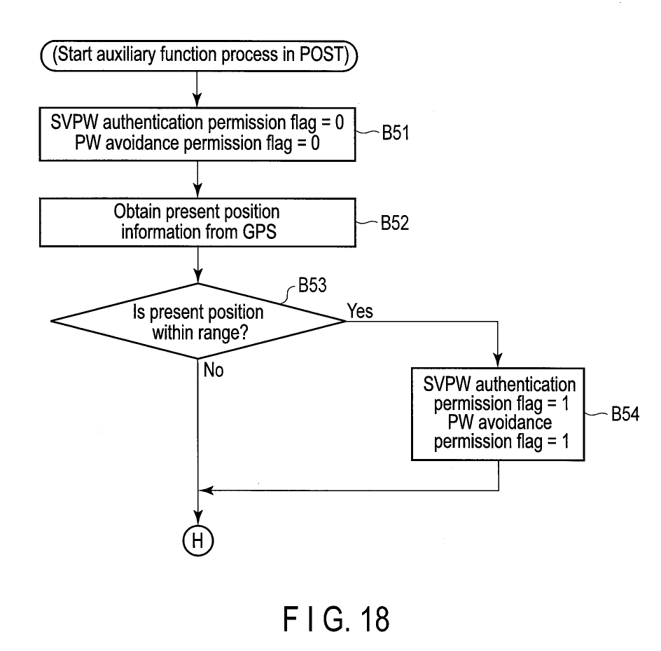

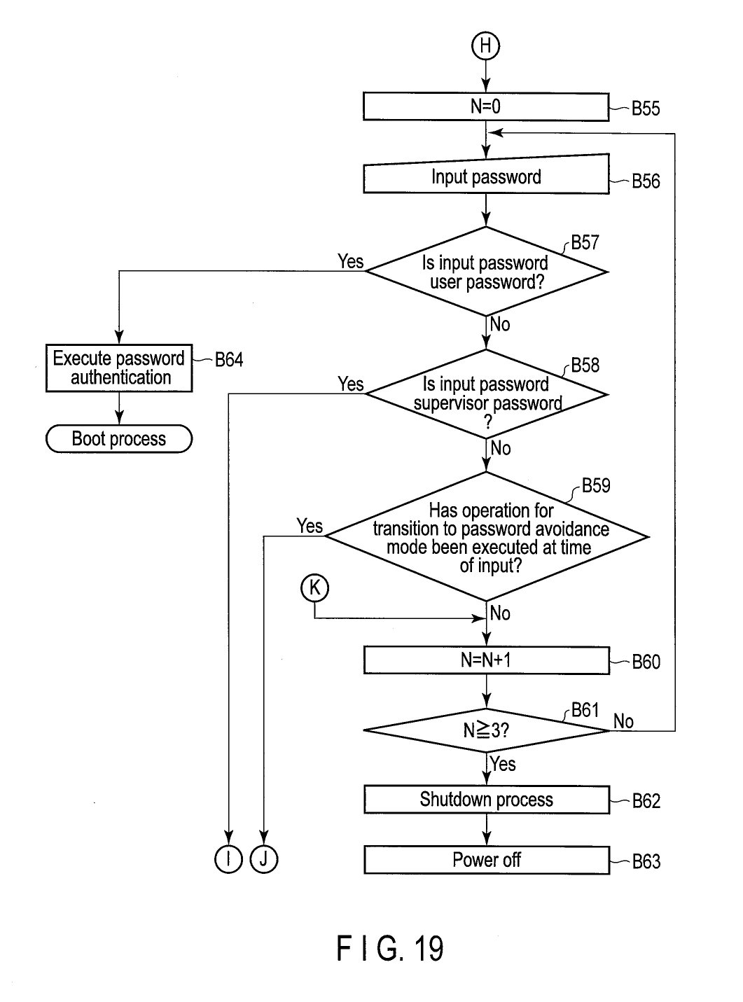

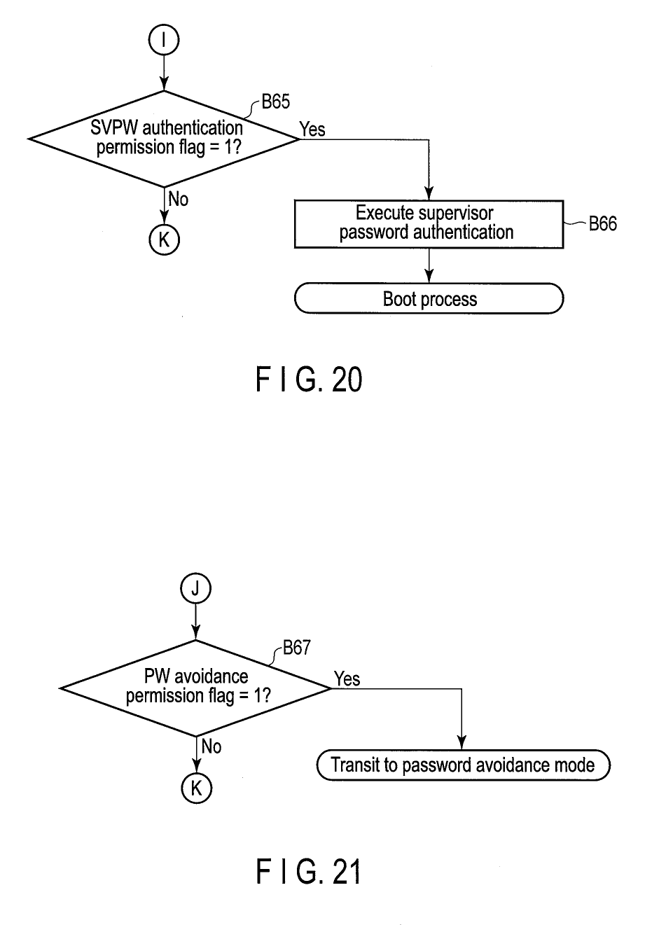

FIG. 18 to FIG. 21 are flowcharts illustrating the procedure of a supervisor password authentication restriction process.

The controller 501 sets “0” for the value of the SVPW authentication permission flag 521 and sets “0” the value of the PW avoidance permission flag 522, which are variables in the memory 113 (block B51).

The range determination module 502 acquires position information indicative of the present position from the GPS module 122 (block B52). The range determination module 502 calculates a distance between the present position indicated by the position information, which has been acquired from the GPS module 122, and the reference position in the permissible range information 513. The range determination module 502 determines whether the present position is within the permissible range, by comparing the calculated distance and the permissible distance in the permissible range information 513 (block B53).

When it has been determined that the present position is within the permissible range (Yes in block B53), the controller 501 sets “1” for the value of the SVPW authentication permission flag 521 and sets “1” for the value of the PW avoidance permission flag 522 in the memory 113 (block B54).

When it has been determined that the present position is not within the permissible range (No in block B53), or after the process of block B54, the controller 501 sets “0” for the value of N indicative of the number of times of input of the password (block B55).

The first display processor 505 executes a process for causing the LCD 31 to display the first input screen shown in FIG. 6. The user performs a password input from the keyboard or an operation for a transition to the PW avoidance mode (block B56).

The controller 501 determines whether the input password agrees with the user password 512 which is registered in the BIOS-ROM 109 (block B57). When it has been determined that the input password agrees with the user password 512 (Yes in block B57), the first authentication processor 507 executes user password authentication (block B64), and then the OS boot module 508 boots the operating system 201.

When it has been determined that the input password does not agree with the user password 512 (No in block B57), the controller 501 determines whether the input password agrees with the supervisor password 511 which is registered in the BIOS-ROM 109 (block B58).

When it has been determined that the input password does not agree with the supervisor password 511, the controller 501 determines whether the operation for the transition to the password avoidance mode was executed when the password was input (block B59). When it has been determined that this operation was not executed (No in block B59), the controller 501 increments the value of N by 1 (block B60). The controller 501 determines whether the value of N is 3 or more (block B61). If it is determined that the value of N is not 3 or more (No in block B61), the BIOS 500 successively executes the process from block B56. If it is determined that the value of N is 3 or more (Yes in block B61), the controller 501 executes a shutdown process (block B62), and powers off the computer 30 (block B63).

When it has been determined in block B58 that the input password agrees with the supervisor password 511 (Yes in block B58), the controller 501 determines whether the value of the SVPW authentication permission flag 521 is “1” or not (block B65). When it has been determined that the value of the SVPW authentication permission flag 521 is not “1” (No in block B65), the BIOS 500 successively executes the process from block B60. When the value of the SVPW authentication permission flag 521 is “0”, SVPW authentication is not executed. It is thus possible to prevent hacking of the supervisor password by a brutal-force attack.

When it has been determined that the value of the SVPW authentication permission flag 521 is “1” (Yes in block B65), the first authentication processor 507 executes supervisor password authentication (block B66), and then the OS boot module 508 boots the operating system 201.

When it has been determined in block B59 that the operation for the transition to the password avoidance mode was executed (Yes in block B59), the controller 501 determines whether the value of the PW avoidance permission flag 522 is “1” or not (block B67). When it has been determined that the value of the PW avoidance permission flag 522 is not “1” (No in block B67), the controller 501 successively executes the process from block B60. When it has been determined that the value of the PW avoidance permission flag 522 is “1”, the BIOS password input avoidance processor 509 executes a transition to the password avoidance mode.

According to the electronic device of the embodiment, when the electronic device is not within the predetermined range, the permission of SVPW authentication is requested from the SVPW authentication server. The SVPW authentication server does not permit the SVPW authentication when the electronic device was stolen or lost. Thereby, it is possible to prevent hacking of the supervisor password by a brutal-force attack.

All the procedures of the supervisor password authentication restriction process in this embodiment can be executed by software. Thus, the same advantageous effects as with the present embodiment can easily be obtained simply by installing a computer program, which executes the procedures of the supervisor password authentication restriction process, into an ordinary computer through a computer-readable storage medium which stores the computer program, and by executing the computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device configured to give a higher priority to a user when first authentication is successfully carried out than when second authentication is successfully carried out, the device comprising:
a nonvolatile memory configured to store a first password used for the first authentication, a second password used for the second authentication, and range information indicative of a permissible range;
a position detector configured to detect a present position of the electronic device;
a first display processor configured to display a first input screen for accepting a third password input when the device is activated; and
a second display processor configured to display a second input screen for accepting the third password input, when the third password, which is input by using an input module when the first screen is displayed, is determined to be the first password and the present position is out of the permissible range.

2. The device of claim 1, further comprising a request module configured to request a permission of the first authentication to an authentication permission apparatus connected to a network, when the present position is out of the permissible range,
wherein the second display processor is configured to display the second input screen, when the third password which is input is determined to be the first password and the permission is not obtained from the authentication permission apparatus.

3. The device of claim 2, further comprising:
a first authentication processor configured to execute the first authentication, when the permission of the first authentication is successfully obtained from the authentication permission apparatus or when the present position is within the permissible range; and
a boot module configured to boot an operating system when the first authentication is successfully carried out.

4. The device of claim 3, further comprising a controller configured to prohibit a change of a setup of the device, when a request for the change of the setup of the device, which requires authentication using the first password, is issued from an application program which is executed on the operating system after the operating system is booted, and the permission is not obtained from the authentication permission apparatus.

5. The device of claim 4, wherein the controller is configured to permit the change of the setup of the device, when the permission is obtained from the authentication permission apparatus.

6. The device of claim 1, wherein the second display processor is configured to display the second input screen, when the present position is out of the permissible range and an operation for avoiding the first authentication and the second authentication is executed on the input module.

7. The device of claim 6, further comprising:
a third display processor configured to display a code input screen for accepting a code input, when the present position is within the permissible range and the operation for avoiding the first authentication and the second authentication is executed on the input module;
a second authentication processor configured to execute third authentication using the code which is input by using the input module when the code input screen is displayed; and
a boot module configured to boot an operating system when the third authentication is successfully carried out.

8. The device of claim 1, further comprising a second request module configured to request a permission of avoidance of the first authentication and the second authentication, to an avoidance permission apparatus connected to the network, when the present position is out of the permissible range,
wherein the second display processor is configured to display the second input screen, when an operation for avoiding the first authentication and the second authentication is executed on the input module and the permission fails to be obtained from the avoidance permission apparatus.

9. The device of claim 8, further comprising:
a third display processor configured to display a code input screen for accepting a code input, when the operation for avoiding the first authentication and the second authentication is executed on the input module;
a second authentication processor configured to execute third authentication using the code which is input by using the input module when the code input screen is displayed; and
a boot module configured to boot an operating system when the third authentication is successfully carried out.

10. An authentication method of an electronic device comprising a nonvolatile memory configured to store a first password used for first authentication, to store a second password used for second authentication, and to store range information indicative of a permissible range which permits a user who successfully carries out the first authentication to have a higher priority than when the second authentication is successfully carried out, the method comprising:
obtaining a present position of the electronic device;
requesting a permission of the first authentication to an authentication permission apparatus connected to a network, when the present position is out of the permissible range,
displaying a first input screen for accepting a password input, when the device is activated; and
displaying a second input screen for accepting the password input, when the password, which is input by using an input module when the first screen is displayed, is determined to be the first password and the present position is out of the permissible range.

11. A computer-readable, non-transitory storage medium having stored thereon a computer program which is executable by a computer comprising a nonvolatile memory configured to store a first password used for first authentication, to store a second password used for second authentication, and to store range information indicative of a permissible range which permits a user who successfully carries out the first authentication to have a higher priority than when the second authentication is successfully carried out, the computer program controlling the computer to execute functions of:
obtaining a present position of the electronic device;
requesting a permission of the first authentication from an authentication permission apparatus connected to a network, when the present position is out of the permissible range;
displaying a first input screen for accepting a password input, when the computer is activated; and
displaying a second input screen for re-accepting a password input, when a password, which is input by using an input module when the first screen is displayed, is determined to be the first password and the permission fail to be obtained from the authentication permission apparatus.
